(19) United States
(12) Patent Application Publication
(10) Pub. No.: US 2014/0293163 A1
(43) Pub. Date: Oct. 2, 2014

(54) TOUCH PANEL

(71) Applicants: Tai Ju, Taipei City (TW); Cheng-Yen Yeh, Taichung City (TW); Kuo-Chang Su, Taichung City (TW); Yu-Ting Chen, Taoyuan County (TW)

(72) Inventors: Tai Ju, Taipei City (TW); Cheng-Yen Yeh, Taichung City (TW); Kuo-Chang Su, Taichung City (TW); Yu-Ting Chen, Taoyuan County (TW)

(73) Assignees: WINTEK CORPORATION, Taichung City (TW); WINTEK (CHINA) TECHNOLOGY LTD., Guangdong Province (CN)

(21) Appl. No.: 14/231,752

(22) Filed: Apr. 1, 2014

(30) Foreign Application Priority Data
Apr. 1, 2013 (TW) 102111715

(51) Int. Cl. G06F 3/044; G06F 1/16

(52) U.S. Cl. CPC G06F 3/044; G06F 1/169
USPC 349/12

(57) ABSTRACT

A touch panel including a carrier component, a plurality of first electrode series and a plurality of second electrode series is provided. Each first electrode series includes a plurality of first electrodes connected in series in a first direction. Each second electrode series includes a plurality of second electrodes connected in series in a second direction. In a unit sensing area arbitrarily selected on the touch panel, a ratio of the unit sensing area occupied by each of the first electrodes to the unit sensing area occupied by each of the second electrodes is 1:1.2 to 1:1.4, wherein a length and a width of the unit sensing area are equal to pitches of the first electrodes in the first direction and the second direction respectively.

### CROSS-REFERENCE TO RELATED APPLICATION

This application claims the priority benefit of Taiwan application serial no. 102111715, filed on Apr. 1, 2013. The entirety of the above-mentioned patent application is hereby incorporated by reference herein and made a part of this specification.

### BACKGROUND

1. Technical Field

The invention relates to a touch panel. Particularly, the invention relates to a capacitive touch panel.

2. Related Art

Touch panels are approximately categorized into resistive touch panels, capacitive touch panels, optical touch panels, acoustic wave touch panels and electromagnetic touch panels according to different sensing manners. Compared to the other types of touch panel, since the capacitive touch panel has the advantages of fast response speed, high reliability and high definition, etc., it is widely applied in various handheld electronic devices. Moreover, a mutual capacitance sensing technology of the capacitive touch panel is quickly developed.

In detail, a mutual capacitive touch panel is configured with a touch electrode unit composed of a driving electrode and a sensing electrode. When a driving signal (voltage) is input to the driving electrode, the sensing electrode may obtain a sensing signal (voltage) based on a coupling effect. When no touch event occurs, a stable mutual capacitance is fonned between the driving electrode and the sensing electrode. When a touch event occurs, the mutual capacitance between the driving electrode and the sensing electrode correspondingly changes, and such change relates to a position and an area size of the touch event, a size of the touch electrode unit and a total length of adjacent side length between the driving electrode and the sensing electrode.

When the electrodes (the sensing electrode and the driving electrode) are designed, the size of the touch electrode unit is an important parameter. Theoretically, the smaller the size of the touch electrode unit is, the better signal linearity and sensitivity of the mutual capacitive touch panel are, though considering processing capability and fabrication cost, the size of the touch electrode unit is limited and cannot be unlimitedly decreased. Therefore, an area of the touch event probably cannot cross over the driving electrode and the sensing electrode, simultaneously (for example, an area of a touch point is too small), which causes inadequate mutual capacitance variation between the driving electrode and the sensing electrode to worsen the touch sensing capability. In other words, the signal linearity and sensitivity of the mutual capacitive touch panel is not ideal.

### SUMMARY

The invention is directed to a touch panel, which has ideal signal linearity and sensitivity without decreasing a size of a touch electrode unit.

The invention provides a touch panel including a carrier component, a plurality of first electrode series and a plurality of second electrode series. The first electrode series and the second electrode series are all carried by the carrier component. Each first electrode series includes a plurality of first connection patterns and a plurality of first electrodes connected in series along a first direction through the first connection patterns, where each of the first electrodes has a first main pattern extending along the first direction and a plurality of first sub patterns connected to the first main pattern. Each second electrode series includes a plurality of second connection patterns and a plurality of second electrodes connected in series along a second direction through the second connection patterns. The second electrode and the first electrode are separated by a gap. Each of the second electrodes has a second main pattern extending along the second direction and a plurality of second sub patterns connected to the second main pattern, where the first sub patterns and the second sub patterns are arranged in alternation. In a unit sensing area arbitrarily selected on the touch panel, a ratio of the unit sensing area occupied by each of the first electrodes to the unit sensing area occupied by each of the second electrodes is 1:1.2 to 1:1.4, where a length and a width of the unit sensing area are respectively equal to pitches of the first electrodes in the first direction and the second direction.

In an embodiment of the invention, a contour of the first electrodes and a contour of the second electrodes are complementary.

In an embodiment of the invention, each of the first electrode series further includes a plurality of first connection patterns for connecting the first electrodes along the first direction to form each of the first electrode series.

In an embodiment of the invention, each of the second electrode series further includes a plurality of second connection patterns for connecting the second electrodes along the second direction to form each of the second electrode series.

In an embodiment of the invention, the gap is from 200 μm to 300 μm.

In an embodiment of the invention, the touch panel further includes a plurality of dummy electrodes located between the first electrodes and the second electrodes. The dummy electrodes are arranged in multiple rows in the gap. A distance between the dummy electrodes and the first electrodes, a distance between the dummy electrodes and the second electrodes, and a distance between the dummy electrodes respectively are not greater than 30 μm.

In an embodiment of the invention, the carrier component includes a plate or a membrane. Moreover, the touch panel further includes a decoration layer, which is disposed at a peripheral area of the carrier component, and the first electrode series and the second electrode series are located at a same side of the carrier component.

In an embodiment of the invention, the carrier component includes a first plate/membrane and a second plate/membrane. The first electrode series and the second electrode series are located between the first plate/membrane and the second plate/membrane, and are separated by an insulation medium. Now, one of the first plate/membrane and the second plate/membrane is, for example, a cover plate. The first electrode series and the second electrode series are located at two opposite sides of the other one of the first plate/membrane and the second plate/membrane. Moreover, the first electrode series is disposed on the first plate/membrane, and the second electrode series is disposed on the second plate/membrane. Now, the first plate/membrane and the second plate/membrane are sequentially stacked, and one of the first electrode series and the second electrode series is located between the first plate/membrane and the second plate/membrane, and the other one is not located therebetween. The touch panel further includes a cover plate. The cover plate is adhered on the first plate/membrane and the second plate/membrane.

In an embodiment of the invention, the first sub patterns of each of the first electrodes extends outwards from the first main pattern, and an extending direction of the first sub patterns is not parallel to the first direction. The extending direction of the first sub patterns is parallel to the second direction. Alternatively, the extending direction of at least one of the first sub patterns extending outwards from the first main pattern points to a center of one of the adjacent second electrodes. Moreover, the extending direction of at least one of the first sub patterns extending outwards from the first main pattern is first parallel to the second direction and then points to the center of one of the adjacent second electrodes. The first sub patterns have different pattern widths.

In an embodiment of the invention, each of the first electrodes and each of the second electrodes respectively have a symmetric contour.

In an embodiment of the invention, each of the second sub patterns of each of the second electrodes includes a main branch and a plurality of sub branches. The sub branches are connected to the main branch, the main branch extends outwards from the second main pattern, and an extending direction of the main branch is not parallel to the second direction. An extending direction of each of the sub branches extending outwards from the main branch is first parallel to the second direction and then points to a center of one of the adjacent first electrodes. Alternatively, the extending direction of each of the sub branches extending outwards from the main branch is parallel to the second direction. Moreover, the extending direction of each of the sub branches extending outwards from the main branch first points to a center of one of the adjacent first electrodes and is then parallel to the second direction. In an embodiment, a width of the main branch is greater than a width of the sub branches.

In an embodiment of the invention, the first electrode series and the second electrode series are made of metal material and patterned in the form of mesh. Moreover, the carrier component comprises an indentation, and the first electrode series and the second electrode series are disposed within the indentation.

According to the above descriptions, in the touch panel according to the embodiments of the invention, the patterns of the first electrodes and the second electrodes have a plurality of branches arranged in alternation. Therefore, the unit sensing area arbitrarily selected on the touch panel covers partial areas of the first electrode and the second electrode, such that the sensing signal of the touch panel has an ideal linearity. Moreover, an area ratio of the first electrode to the second electrode is adjusted for improving sensitivity of touch sensing. Therefore, the first electrode and the second electrode have ideal sensing yield without decreasing the sizes thereof.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial top view of a touch panel according to a first embodiment of the invention.

FIG. 2 is a partial top view of a touch panel according to a second embodiment of the invention.

FIG. 3 is a partial top view of a touch panel according to a third embodiment of the invention.

FIG. 4 is a partial layout schematic diagram of a first electrode, a second electrode and a dummy electrode according to an embodiment of the invention.

FIG. 5 is a partial layout schematic diagram of a first electrode, a second electrode and a dummy electrode according to another embodiment of the invention.

FIG. 6 is a partial layout schematic diagram of a first electrode, a second electrode and a dummy electrode according to still another embodiment of the invention.

FIG. 7-FIG. 11 are cross-sectional views of touch panels of a plurality of embodiments of the invention.

FIG. 12 is a schematic diagram illustrating a touch display device according to an embodiment of the invention.

### DETAILED DESCRIPTION OF DISCLOSED EMBODIMENTS

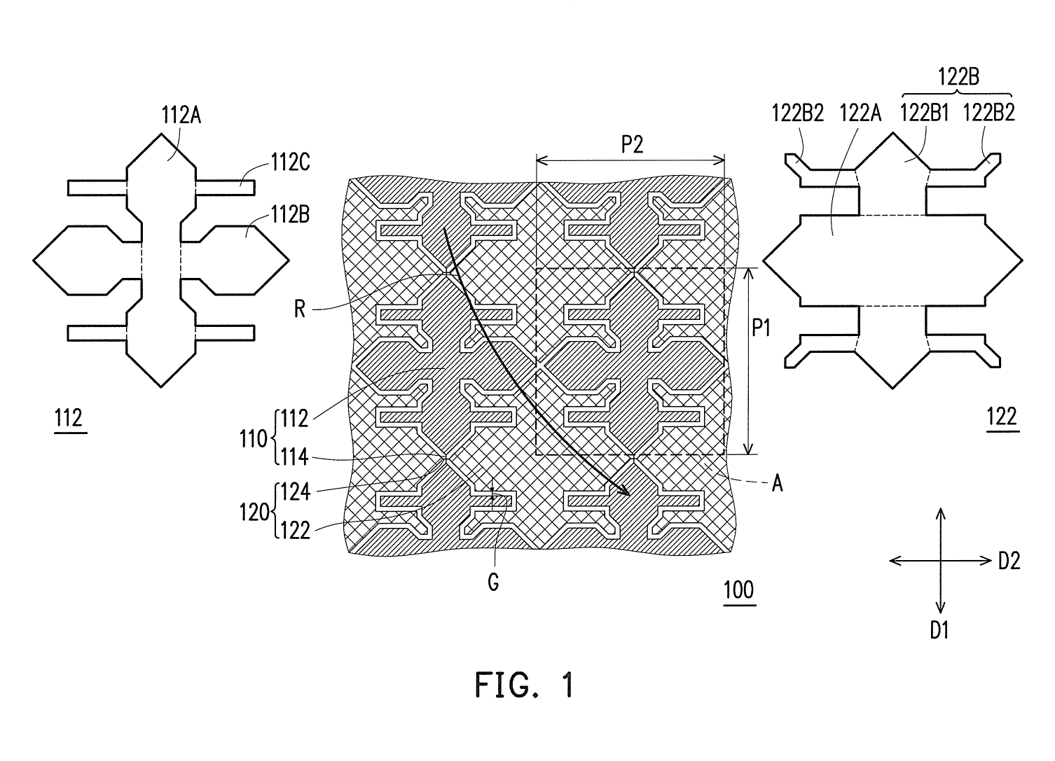

FIG. 1 is a partial top view of a touch panel according to a first embodiment of the invention. Referring to FIG. 1, the touch panel 100 includes a plurality of first electrode series 110 and a plurality of second electrode series 120. Each first electrode series 110 includes a plurality of first electrodes 112 and a plurality of first connection patterns 114, where the first connection patterns 114 connect the first electrodes 112 in series along a first direction D1. Each second electrode series 120 includes a plurality of second electrodes 122 and a plurality of second connection patterns 124, where the second connection patterns 124 connect the second electrodes 122 in series along a second direction D2.

In detail, the first electrode series 110 and the second electrode series 120 can be carried by a carrier component (not shown) made of organic material including SiOx, polyimide, polypropylene, polyethylene, polycarbonate, polyrnethyl methacrylate, polyether ketone, cyclic olefin copolymer, acrylic resin or epoxy resin. However, in order to clearly present the design of the electrodes, only the electrodes are illustrated in FIG. 1, and the carrier component is not illustrated. Moreover, in FIG. 1, the first connection patterns 114 and the second connection patterns 124 are only schematically represented by straight lines, though in an actual design, the first connection patterns 114 and the second connection patterns 124 can be composed of metal wires or a metal mesh, or can be made of the same materials as that of the corresponding electrodes (the first electrodes 112 or the second electrodes 122). For example, the first connection patterns 114 and the first electrodes 112 can be fabricated in a same fabrication step by using the same material, and the second connection patterns 124 and the second electrodes 122 can be fabricated in a same fabrication step by using the same material. Therefore, each of the first electrode series 110 or the second electrode series 120 can be selectively composed of a continuous conductive pattern.

In the present embodiment, each of the first electrodes 112 is composed of a first main pattern 112A and a plurality of first sub patterns 112B and 112C. The first main pattern 112A mainly extends along the first direction D1, and the ends of the first main pattern 112A are respectively connected to the first connection patterns 114. The first sub patterns 112B and 112C are all connected to the first main pattern 112A and extend outward from the first main pattern 112A. Here, each of the first electrodes 112 is substantially composed of a continuous or integral conductive pattern, and the aforementioned main pattern and the sub patterns are divided into different portions according to contours and extending directions of the portions. Therefore, in an actual design, the main pattern and the sub patterns have no boundary therebetween.

An extending direction of the first sub pattern 112B or the first sub pattern 112C extending outwards from the first main pattern 112A is not parallel to the first direction D1. Therefore, the first sub pattern 112B approximately extends along the second direction D2 from the first main pattern 112A to the first electrode 112 of the adjacent first electrode series 110. Moreover, the first sub pattern 112C approximately extends along the second direction D2 from the first main pattern 112A to a central line of the adjacent second electrode 122.

The pattern of the second electrode 122 is, for example, composed of a second main pattern 122A and a plurality of second sub patterns 122B connected to the second main pattern 122A. Here, a main extending direction of the second main pattern 122A is approximately parallel to the second direction D2, and the ends of the second main pattern 122A are respectively connected to the corresponding second connection patterns 124. Moreover, in the present embodiment, each of the second sub patterns 122B includes a main branch 122B1 and a plurality of sub branches 122B2, where the sub branches 122B2 extend outwards from the main branch 122B1 and are indirectly connected to the second main pattern 122A through the main branch 122B1. In other words, the sub branches 122B2 do not contact the second main pattern 122A. Moreover, in the design of the present embodiment, a width of the main branch 122B1 can be selectively greater than a width of the sub branches 122B2.

According to FIG. 1, the main branch 122B1 of each of the second sub patterns 122B approximately extends outwards from the second main pattern 122A along the first direction D1, i.e. an extending direction of the main branch 122B1 is not parallel to the second direction D2. Moreover, each of the sub branches 122B2 first extends from the main branch 122B1 along the second direction D2 and then extends towards a center of the adjacent first electrode 112. In this way, the first sub patterns 112B and 112C and the second sub patterns 122B can be arranged in alternation. Moreover, in the present embodiment, the first electrode 112 and the second electrode 122 respectively have a symmetric contour, and the contours of the first electrode 112 and the second electrode 122 are approximately complementary.

In the touch panel 100, the first electrode series 110 can be regarded as sensing electrodes, and the second electrode series 120 can be regarded as driving electrodes. When a user touches the touch panel 100 by a finger, the touch panel 100 determines a touch position of the finger according to a mutual capacitance variation between the first electrode series 110 and the second electrode series 120. Since the first electrodes 112, the sensing electrodes, are used to receive signals, the larger the area of the first electrodes 112 is, the more external noise is received. Therefore, when the electrodes are designed, the area of the second electrodes 122 is designed to be larger and the area of the first electrodes 112 is designed to be smaller. However, small area of the first electrodes 112 leads to problems of excessively high resistance of the first electrode series 110, inadequate signal coupling amount, etc. Therefore, an area ratio of the first electrodes 112 and the second electrodes 122 can be adjusted according to the design of the touch panel 100.

In the present embodiment, in a unit sensing area A arbitrarily selected on the touch panel 100, a ratio of an area occupied by the first electrode 112 to an area occupied by the second electrode 122 is 1:1.2 to 1:1.4, where a length and a width of the unit sensing area A are respectively equal to a pitch P1 and a pitch P2 of the first electrodes 112 in the first direction D1 and the second direction D2. When the user directly operates the touch panel 100 by fingers, a size of the unit sensing area A is, for example, set to 5 mm². Now, regardless of any position where the finger touches the touch panel 100, a contact area of the finger may cover partial areas of the first electrode 112 and the second electrode 122, and an area ratio of the contacted first electrode 112 to the second electrode 122 is 1:1.2 to 1:1.4. Therefore, the touch panel 100 may effectively perform touch sensing. Particularly, when a conductor, for example, the finger moves on the touch panel 100 along a specific track (for example, a track R), the signals received by the first electrode series 110 may present a good linearity to achieve better touch sensing sensitivity. However, the aforementioned values are only used as an example, and the invention is not limited thereto.

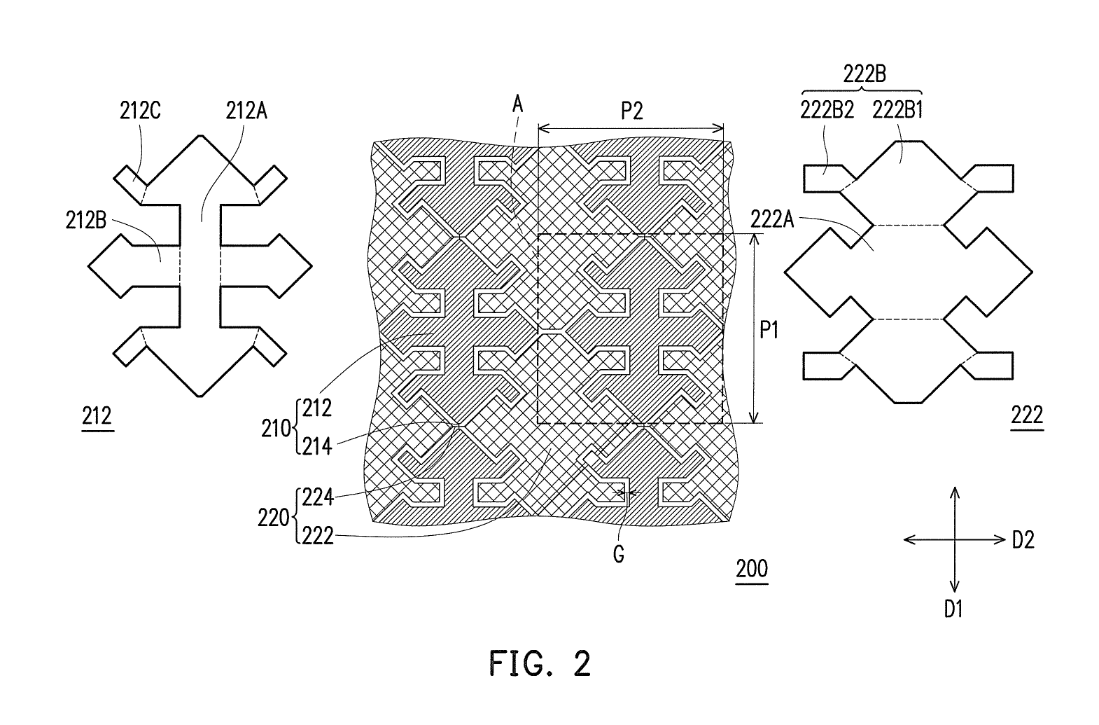

FIG. 2 is a partial top view of a touch panel according to a second embodiment of the invention. Referring to FIG. 2, the touch panel 200 is similar to the touch panel 100, and includes a plurality of first electrode series 210 and a plurality of second electrode series 220. Certainly, the first electrode series 210 and the second electrode series 220 can be carried by a carrier component. However, in order to clearly present the design of the electrodes, the carrier component is not illustrated in FIG. 2. Each first electrode series 210 includes a plurality of first electrodes 212 and a plurality of first connection patterns 214 connecting the first electrodes 212 in series along the first direction D1. Each second electrode series 220 includes a plurality of second electrodes 222 and a plurality of second connection patterns 224 connecting the second electrodes 222 in series along the second direction D2. The first connection patterns 214 and the second connection patterns 224 are intersected and are electrically isolated to each other. Moreover, the second electrodes 222 and the first electrodes 212 are spaced by a gap G, and the first electrodes 212 are not overlapped to the second electrodes 222.

Each of the first electrodes 212 has a first main pattern 212A extending along the first direction D1 and a plurality of first sub patterns 212B and 212C connected to the first main pattern 212A. The first main pattern 212A is, for example, a pattern having double arrows, and the first main pattern 212A mainly extends along the first direction D1. Extending directions of the first sub patterns 212B and 212C are not parallel to the first direction D1. The first sub pattern 212B can be connected to a central portion of the first main pattern 212A, and approximately extends outwards from the first main pattern 212A along the second direction D2. The first sub pattern 212C is, for example, connected to an end portion of the first main pattern 212A, and approximately extends from the first main pattern 212A towards a center of the adjacent second electrode 222. Now, an extending direction of the first sub pattern 212C is neither parallel to the first direction D1 nor parallel to the second direction D2. However, such pattern design is only used as an example, and the invention is not limited thereto.

A contour of each second electrode 222 can be approximately divided into a second main pattern 222A and a plurality of second sub patterns 222B connected to the second main pattern 222A, where each of the second sub patterns 222B is further composed of a main branch 222B1 and a plurality of sub branches 222B2. The second main pattern 222A is defined as a pattern extending along the second direction D2, and two ends of the second main pattern 222A are respectively connected to the corresponding second connection patterns 224. The main branch 222B1 in the second sub pattern 222B extends outwards from the second main pattern 222A, and an extending direction of the main branch 222B1 can be selectively parallel to the first direction D1. The sub branches 222B2 are connected to the main branch 222B1 and extend outwards from the main branch 222B1. Each of the sub branches 222B2, for example, first extends towards the center of the adjacent first electrode 212 and then extends along the second direction D2. In this way, contours of the first electrode 212 and the second electrode 222 are approximately complementary to implement a planar sensing electrode distribution. Here, the first electrodes 212 and the second electrodes 222 respectively have a symmetric pattern design.

In a unit sensing area A arbitrarily selected on the touch panel 200, a ratio of an area occupied by the first electrode 212 to an area occupied by the second electrode 222 is 1:1.2 to 1:1.4, where a length and a width of the unit sensing area A are respectively equal to a pitch P1 and a pitch P2 of the first electrodes 212 in the first direction D1 and the second direction D2. In the present embodiment, a size of the unit sensing area A is set to 5 mm², though the invention is not limited thereto. As that described in the aforementioned embodiments, regardless of any position where the finger touches the touch panel 200, a contact area of the finger may cover a certain area proportion of the first electrode 112 and the second electrode 122 to implement effective touch sensing. Particularly, when the finger moves on the touch panel 200 along a specific track, the signals received by the first electrode series 210 may present a good linearity to achieve better touch sensing sensitivity. Here, the size of the unit sensing area A is only used as an example, and the invention is not limited thereto. Actually, the sizes of the first electrode 212 and the second electrode 222 can be determined according to a size, a resolution requirement and a using method of the touch panel 200. Therefore, the size of the unit sensing area A can be greater than or equal to 5 mm².

FIG. 3 is a partial top view of a touch panel according to a third embodiment of the invention. Referring to FIG. 3, the touch panel 300 includes a plurality of first electrode series 310 and a plurality of second electrode series 320. The first electrode series 310 and the second electrode series 320 can be carried by a carrier component. However, the carrier component is not illustrated in FIG. 3. Each first electrode series 310 includes a plurality of first electrodes 312 and a plurality of first connection patterns 314 connecting the first electrodes 312 in series along the first direction D1.

Each second electrode series 320 includes a plurality of second electrodes 322 and a plurality of second connection patterns 324 connecting the second electrodes 322 in series along the second direction D2. The first connection patterns 314 and the second connection patterns 324 are intersected and are electrically isolated to each other. Moreover, the second electrodes 322 and the first electrodes 312 are spaced by a gap G, and the first electrodes 312 are not overlapped with the second electrodes 322. Each of the first electrodes 312 has a first main pattern 312A extending along the first direction D1 and a plurality of first sub patterns 312B and 312C connected to the first main pattern 312A. The first main pattern 312A is, for example, a long stripe pattern having tips at both ends, and the first main pattern 312A mainly extends along the first direction D1. Extending directions of the first sub patterns 312B and 312C are not parallel to the first direction D1. The first sub pattern 312B can be connected to a central portion of the first main pattern 312A, and approximately extends outwards from the first main pattern 312A along the second direction D2. The first sub pattern 312C is, for example, connected to an end portion of the first main pattern 312A, and approximately extends outwards from the first main pattern 312A along the second direction D2 and then extends towards a center of the adjacent second electrode 322. However, such pattern design is only used as an example, and the invention is not limited thereto.

A contour of each second electrode 322 can be approximately divided into a second main pattern 322A and a plurality of second sub patterns 322B connected to the second main pattern 322A, where each of the second sub patterns 322B is further composed of a main branch 322B1 and a plurality of sub branches 322B2. The second main pattern 322A is defined as a pattern extending along the second direction D2, and two ends of the second main pattern 322A are respectively connected to the corresponding second connection patterns 324. The main branch 322B1 of the second sub pattern 322B extends outwards from the second main pattern 322A, and an extending direction of the main branch 322B1 can be selectively parallel to the first direction D1. The sub branches 322B2 are connected to the main branch 322B1 and extend outwards from the main branch 322B1 along the second direction D2. In this way, contours of the first electrode 312 and the second electrode 322 are approximately complementary to implement a planar sensing electrode distribution.

Similar to the aforementioned embodiment, in a unit sensing area A arbitrarily selected on the touch panel 300, a ratio of an area occupied by the first electrode 312 to an area occupied by the second electrode 322 is 1:1.2 to 1:1.4, where a length and a width of the unit sensing area A are respectively equal to a pitch P1 and a pitch P2 of the first electrodes 312 in the first direction D1 and the second direction D2. In this way, the touch panel 300 may have ideal touch sensing sensitivity. Actually, the sizes of the first electrode 312 and the second electrode 322 can be determined according to a size, a resolution requirement and a using method of the touch panel 300. Therefore, the size of the unit sensing area A can be greater than or equal to 5 mm².

In the aforementioned embodiments, since contours of the first electrodes 112, 212 and 312 and the second electrodes 122, 222 and 322 are respectively patterns having a plurality of branches, a perimeter of each electrode contour is obviously increased. Now, capacitance coupling effects between the first electrodes 112, 212 and 312 and the second electrodes 122, 222 and 322 are obviously increased based on increase of the perimeter of the contour, which leads to an obvious increase of a load of a driving chip. In order to decrease the load of the driving chip, the gaps G between the first electrodes 112, 212 and 312 and the second electrodes 122, 222 and 322 can be suitably adjusted. A following table 1 lists the influences on the loads of the driving chip and capacitance variation rates received by the driving chip caused by the gaps G between the first electrodes 112, 212 and 312 and the second electrodes 122, 222 and 322. In other embodiment, the aforementioned first electrode series and second electrode series are made of metal material and patterned in the form of mesh with 0.8 μm-10 μm line width. Moreover, the first electrode series and second electrode series can be disposed within the indentation on the carrier component to provide another type of the touch panel.

TABLE 1
Influences on loads of the driving chip and capacitance variation rates
received by the driving chip caused by the gaps G

| | Gap G (μm) | | | | | | |
|---|---|---|---|---|---|---|---|
| | 30 | 50 | 100 | 150 | 200 | 250 | 300 |
| Capac- | 100% | 88.38% | 71.46% | 62.98% | 56.79% | 52.33% | 48.65% |
| itance | | | | | | | |
| load | | | | | | | |
| Capac- | 100% | 101.89% | 100.17% | 97.18% | 98.07% | 96.17% | 95.42% |
| itance | | | | | | | |
| variation | | | | | | | |
| rate ΔC | | | | | | | |

According to the table 1, it takes the embodiment of gap G of 30 μm for standard, and the gap G comparative relation of percentage is based thereon for illustration. Increasing the gap G can reduce the load of the driving chip, but also reduce the capacitance variation rate wherein the higher capacitance variation rate brings the superior touch accuracy. When the gap G is increased to be greater than 200 μm, the load can be decreased by about 50%, and the capacitance variation rate is still maintained to be above 95%. Therefore, in the electrode designs of the aforementioned embodiments, the gaps G can be selectively set to a size between 200 μm and 300 μm to maintain ideal touch sensing sensitivity. However, the increased gaps G result in a fact that the user perceives the existence of the gaps G, which is unfavorable to visual effects of the touch panels 100-300. Therefore, dummy electrodes can be selectively disposed between the first electrodes 112, 212 and 312 and the second electrodes 122, 222 and 322 to improve the visual effects of the touch panels 100-300. Embodiments are provided below with reference of figures to describe designs and layouts of the first electrodes, the second electrodes and the dummy electrodes, though the invention is not limited thereto.

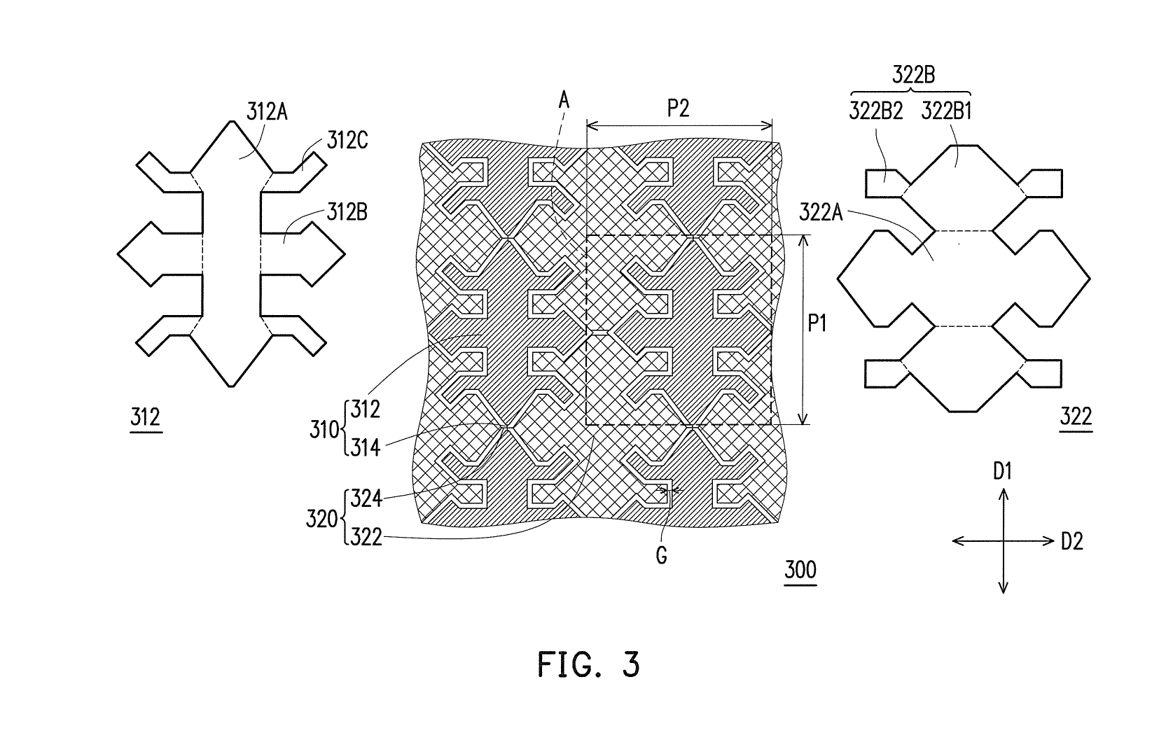

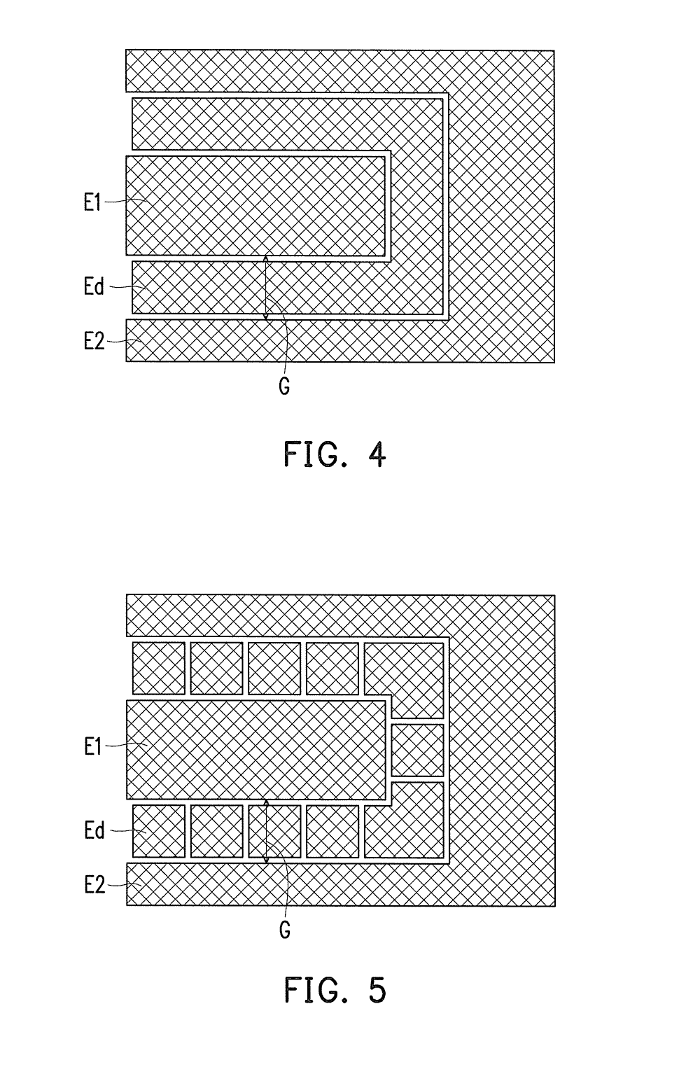

FIG. 4 is a partial layout schematic diagram of a first electrode, a second electrode and a dummy electrode according to an embodiment of the invention. Referring to FIG. 4, the first electrode E1 and the second electrode E2 are separated by the gap G, and the dummy electrode Ed is, for example, disposed between the first electrode E1 and the second electrode E2 to fill the area of the gap G. Here, the dummy electrode Ed is disposed in accordance with the contour of the gap G. Moreover, in order to avoid electrical connection between the electrodes E1 and E2 and provide a good visual effect, a distance between the dummy electrode Ed and the first electrode E1 and a distance between the dummy electrode Ed and the second electrode E2 are not greater than 30 μm.

FIG. 5 is a partial layout schematic diagram of a first electrode, a second electrode and a dummy electrode according to another embodiment of the invention. Referring to FIG. 5, the first electrode E1 and the second electrode E2 are separated by the gap G, and the dummy electrode Ed is, for example, disposed between the first electrode E1 and the second electrode E2 to fill the area of the gap G. Here, the dummy electrode Ed is composed of a plurality of sections, and the sections are disposed in accordance with the contour of the gap G. A distance between the dummy electrode Ed and the first electrode E1 and a distance between the dummy electrode Ed and the second electrode E2 are not greater than 30 μm. Moreover, a distance between the sections of the dummy electrode Ed is not greater than 30 μm.

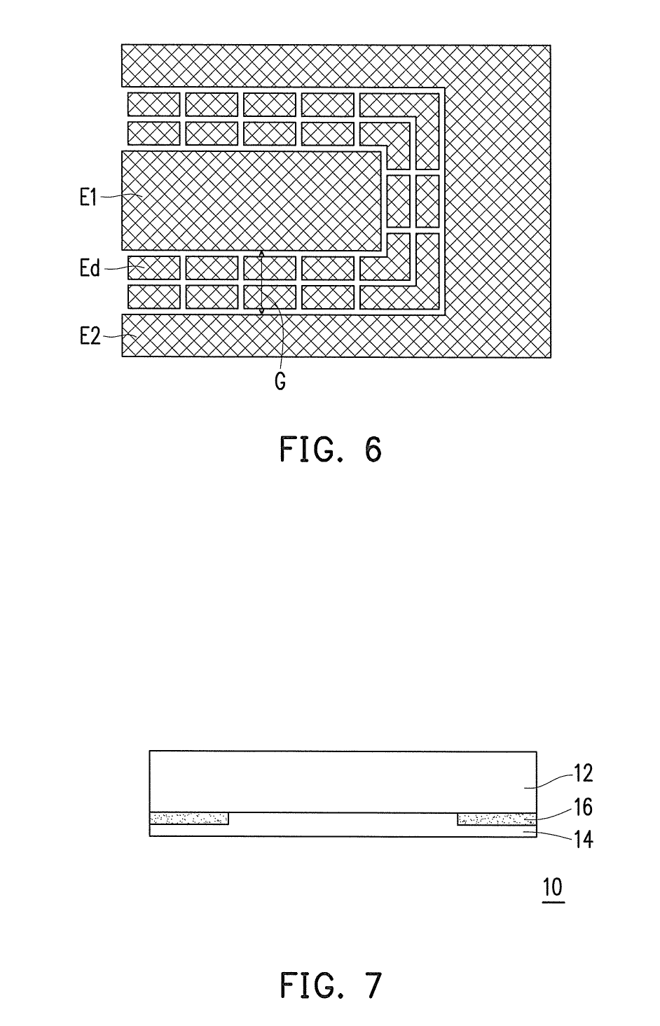

FIG. 6 is a partial layout schematic diagram of a first electrode, a second electrode and a dummy electrode according to still another embodiment of the invention. Referring to FIG. 6, the first electrode E1 and the second electrode E2 are separated by the gap G, and the dummy electrode Ed is, for example, disposed between the first electrode E1 and the second electrode E2 to fill the area of the gap G. Here, the dummy electrode Ed is composed of a plurality of sections, and the sections are disposed in two rows in accordance with the contour of the gap G. Now, a distance between the dummy electrode Ed and the first electrode E1 and a distance between the dummy electrode Ed and the second electrode E2 are not greater than 30 μm. Moreover, a distance between the sections of the dummy electrode Ed is not greater than 30 μm. In overall, the dummy electrodes Ed of FIG. 4 to FIG. 6 can be applied to any one of the touch panels 100-300 to improve the visual effect thereof Moreover, a following table 2 lists the influences on the loads of the driving chip and capacitance variation rates received by the driving chip due to configuration of the dummy electrodes.

TABLE 2
Influences on loads of driving chip and capacitance variation rates
received by the driving chip due to configuration of dummy electrodes

| | | | Dummy | Dummy |
|---|---|---|---|---|
| | No dummy | Dummy electrode | electrode | electrode |
| | electrode | of FIG. 4 | of FIG. 5 | of FIG. 6 |
| Capacitance | 100.00% | 120.40% | 114.12% | 114.60% |
| load | | | | |
| Capacitance | 100.00% | 84.95% | 105.69% | 92.71% |
| variation rate | | | | |
| ΔC | | | | |

According to the table 2, by disposing the dummy electrode Ed between the first electrode E1 and the second electrode E2, the load of the driving chip is slightly increased, though the ideal capacitance variation rate can still be achieved. Therefore, configuration of the dummy electrode Ed can indeed improve the visual effects of the touch panels 100-300 effectively, and keep ideal sensing yields of the touch panels 100-300.

FIG. 7-FIG. 11 are cross-sectional views of touch panels of a plurality of embodiments of the invention. Referring to FIG. 7, the touch panel 10 includes a carrier component 12, a touch element 14 and a decoration layer 16. The carrier component 12 can be a transparent substrate or a plate/membrane such as a cover plate, etc. with an ideal mechanism strength to provide protection and cover functions for touch element 14. The touch element 14 may include the first electrode series 110, 210 or 310 and the second electrode series 120, 220 or 320 in any one of the aforementioned embodiments. Moreover, the decoration layer 16 is disposed at a peripheral region of the carrier component 12 and is located between the touch element 14 and the carrier component 12. When any one of the touch panels 100-300 of the aforementioned embodiments has a cross-sectional structure design as that of the touch panel 10 of FIG. 7, the first electrode series 110, 210 or 310 and the second electrode series 120, 220 or 320 are simultaneously disposed at a same side of the plate-like carrier component 12. Certainly, the invention is not limited thereto.

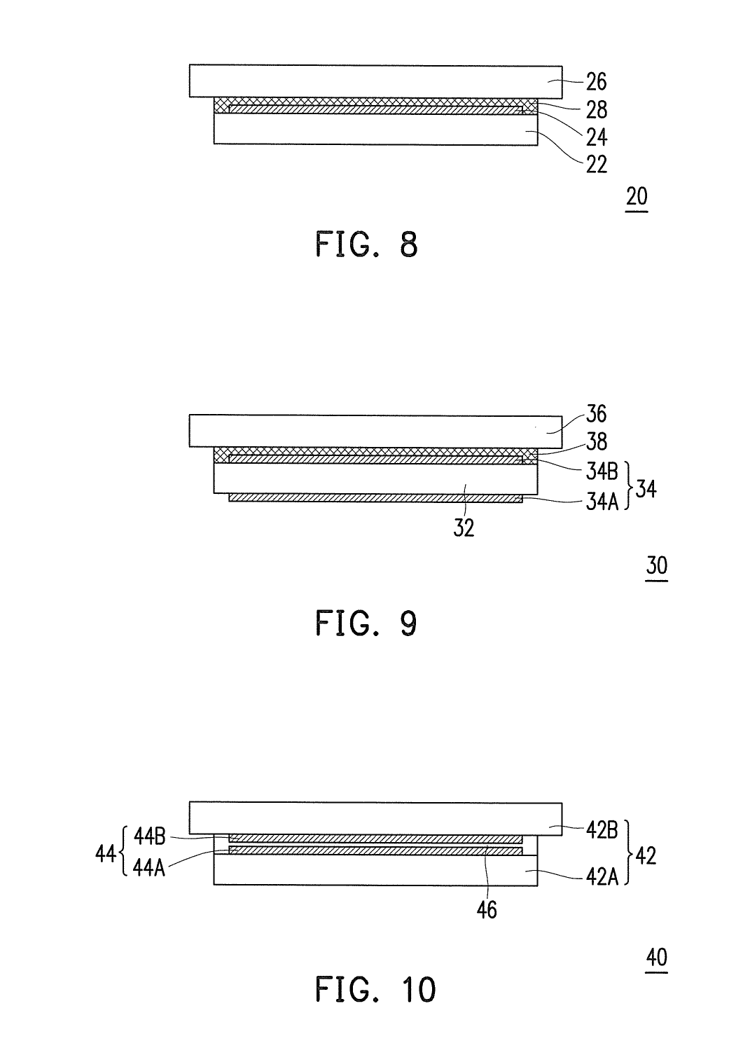

Referring to FIG. 8, a touch panel 20 includes a carrier component 22, a touch element 24, a cover plate 26 and an adhesive 28. The touch element 24 is disposed on the carrier component 22 and substantially includes the first electrode series 110, 210 or 310 and the second electrode series 120, 220 or 320 of any one of the aforementioned embodiments. The carrier component 22 and the cover plate 26 are respectively a plate/membrane and are adhered through the adhesive 28, where the adhesive 28 can be an optical adhesive or other adhesive materials capable of adhering the cover plate 26 and the carrier component 22 without influencing the visual effect of the touch panel 20. In the present embodiment, the carrier component 22 is a plastic thin film and the cover plate 26 is glass, though in other embodiments, the carrier component 22 and the cover plate 26 can all be glass. Now, the touch element 24 is, for example, located between the carrier component 22 and the cover plate 26. When any one of the touch panels 100-300 of the aforementioned embodiments has a cross-sectional structure design as that of the touch panel 20 of FIG. 8, the first electrode series 110, 210 or 310 and the second electrode series 120, 220 or 320 are simultaneously disposed at a same side of the plate-like carrier component 22.

Referring to FIG. 9, a touch panel 30 includes a carrier component 32, a touch element 34, a cover plate 36 and an adhesive 38. The carrier component 32 is a plate/membrane. The touch element 34 is disposed on the carrier component 32 and substantially includes a first electrode layer 34A and a second electrode layer 34B disposed at two opposite sides of the carrier component 32. The first electrode layer 34A may include the first electrode series 110, 210 or 310 of any one of the aforementioned embodiments, and the second electrode layer 34B may include the second electrode series 120, 220 or 320 of any one of the aforementioned embodiments. Alternatively, the first electrode layer 34A includes the second electrode series 120, 220 or 320 of any one of the aforementioned embodiments, and the second electrode layer 34B includes the first electrode series 110, 210 or 310 of any one of the aforementioned embodiments. Namely, when any one of the touch panels 100-300 of the aforementioned embodiments has a cross-sectional structure design as that of the touch panel 30 of FIG. 9, the first electrode series 110, 210 or 310 and the second electrode series 120, 220 or 320 are respectively disposed at two opposite sides of the plate-like carrier component 32. Moreover, the cover plate 36 is a plate/membrane having an ideal mechanical strength and is adhered to the carrier component 32 through the adhesive 38, where the adhesive 38 can be an optical adhesive or other adhesive materials capable of adhering the cover plate 36 and the carrier component 32 without influencing the visual effect of the touch panel 30.

Referring to FIG. 10, a touch panel 40 includes a carrier component 42, a touch element 44 and an adhesive 46. The carrier component 42 includes a first substrate 42A and a second substrate 42B adhered with each other through the adhesive 46. The touch element 44 is disposed on the carrier component 42 and substantially includes a first electrode layer 44A and a second electrode layer 44B. The first electrode layer 44A and the second electrode layer 44B can be respectively disposed on the first substrate 42A and the second substrate 42B. The first electrode layer 44A may include the first electrode series 110, 210 or 310 of any one of the aforementioned embodiments, and the second electrode layer 44B may include the second electrode series 120, 220 or 320 of any one of the aforementioned embodiments. Alternatively, the first electrode layer 44A includes the second electrode series 120, 220 or 320 of any one of the aforementioned embodiments, and the second electrode layer 44B includes the first electrode series 110, 210 or 310 of any one of the aforementioned embodiments. Namely, when any one of the touch panels 100-300 of the aforementioned embodiments has a cross-sectional structure design as that of the touch panel 40 of FIG. 10, the first electrode series 110, 210 or 310 and the second electrode series 120, 220 or 320 are respectively disposed on the first substrate 42A and the second substrate 42B of the carrier component 32. Now, the second substrate 42B can be selectively a cover plate having an ideal mechanical strength, and an area of the second substrate 42B can be greater than an area of the first substrate 42A.

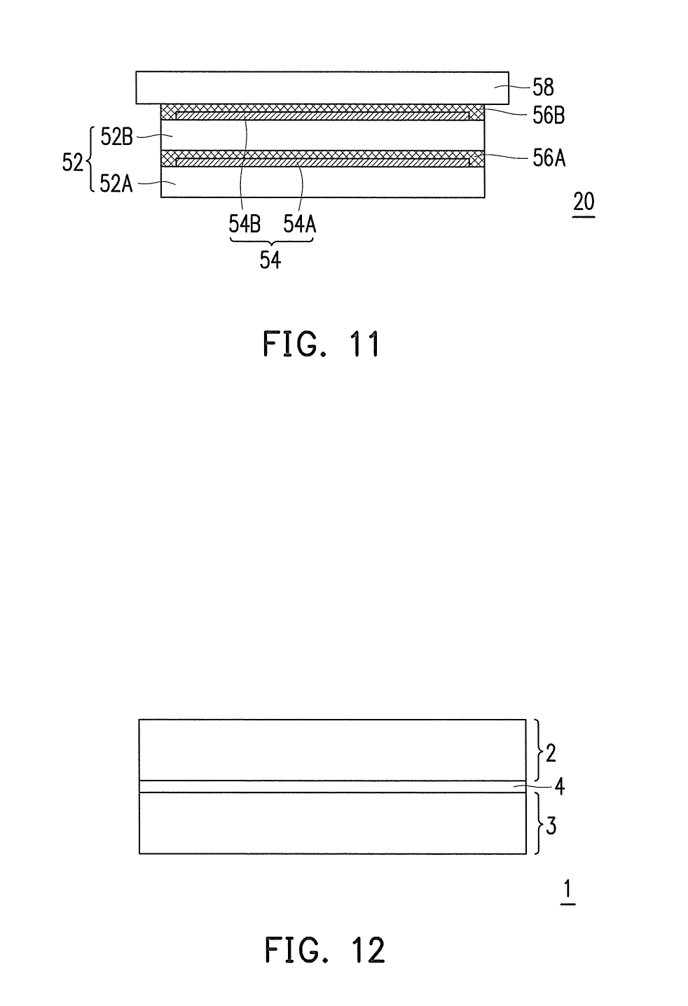

Referring to FIG. 11, a touch panel 40 includes a carrier component 52, a touch element 54, adhesives 56A and 56B and a cover plate 58. The carrier component 52 includes a first substrate 52A and a second substrate 52B, and the touch element 54 includes a first electrode layer 54A and a second electrode layer 54B, where the first electrode layer 54A and the second electrode layer 54B can be respectively disposed on the first substrate 52A and the second substrate 52B. The first substrate 52A and the second substrate 52B are adhered through the adhesive 56A, and the cover plate 58 is adhered to the second substrate 52B through the adhesive 56B. In the present embodiment, the first electrode layer 54A is disposed on the first substrate 52A at a side adjacent to the cover plate 58, and the second electrode layer 54B is disposed on the second substrate 52B at a side adjacent to the cover plate 58. Therefore, the first electrode layer 54A is located between the first substrate 52A and the second substrate 52B, and the second electrode layer 54B is not located therebetween. In detail, the second electrode layer 54B is located between the second substrate 52B and the cover plate 58. The first electrode layer 54A may include the first electrode series 110, 210 or 310 of any one of the aforementioned embodiments, and the second electrode layer 54B may include the second electrode series 120, 220 or 320 of any one of the aforementioned embodiments. Alternatively, the first electrode layer 54A includes the second electrode series 120, 220 or 320 of any one of the aforementioned embodiments, and the second electrode layer 54B includes the first electrode series 110, 210 or 310 of any one of the aforementioned embodiments.

FIG. 12 is a schematic diagram illustrating a touch display device according to an embodiment of the invention. Retelling to FIG. 12, the touch display device 1 includes a touch panel 2 and a display panel 3, where the touch panel 2 may have a structure design of any of the aforementioned touch panels 10-50 and have an electrode design of any of the aforementioned touch panels 100-300. Moreover, the touch panel 2 and the display panel 3 can be adhered through an adhesion layer 4.

In summary, in the touch panel of the invention, the electrode patterns have a plurality of branches arranged in alternation. When the unit sensing area is arbitrarily selected on the touch panel, the unit sensing area covers a part of the driving electrode and a part of the sensing electrode, and the sensing electrode and the driving electrode in the unit sensing area have a certain area ratio. In this way, the touch panel of the invention has ideal touch sensing sensitivity and better signal linearity.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel, comprising:
a carrier component;
a plurality of first electrode series, carried by the carrier component, and each of the first electrode series comprising a plurality of first electrodes and a plurality of first connection patterns, wherein the first connection patterns connect the first electrode in series along a first direction; and
a plurality of second electrode series, carried by the carrier component, and each of the second electrode series comprising a plurality of second electrodes and a plurality of second connection patterns, wherein the second connection patterns connect the second electrode in series along a second direction, and the second electrode and the first electrodes are separated by a gap;
wherein in a unit sensing area arbitrarily selected on the touch panel, a ratio of the unit sensing area occupied by each of the first electrodes to the unit sensing area occupied by each of the second electrodes is 1:1.2 to 1:1.4.

2. The touch panel as claimed in claim 1, wherein a contour of the first electrodes and a contour of the second electrodes are complementary.

3. The touch panel as claimed in claim 1, wherein the gap is from 200 μm to 300 μm.

4. The touch panel as claimed in claim 1, further comprising a plurality of dummy electrodes located between the first electrodes and the second electrodes.

5. The touch panel as claimed in claim 4, wherein the dummy electrodes are arranged in multiple rows in the gap.

6. The touch panel as claimed in claim 4, wherein a distance between the dummy electrodes and the first electrodes, a distance between the dummy electrodes and the second electrodes, and a distance between the dummy electrodes respectively are not greater than 30 μm.

7. The touch panel as claimed in claim 1, wherein the carrier component comprises a plate or a membrane.

8. The touch panel as claimed in claim 7, further comprising a decoration layer at least disposed at a portion of a peripheral area of the carrier component, wherein the first electrode series and the second electrode series are located at a same side of the carrier component.

9. The touch panel as claimed in claim 1, wherein the carrier component comprises a first plate/membrane and a second plate/membrane.

10. The touch panel as claimed in claim 9, wherein the second plate/membrane is a cover plate.

11. The touch panel as claimed in claim 10, wherein the first plate/membrane is a membrane, and the first electrode series and the second electrode series are located between the cover plate and the membrane, and are separated by an insulation medium.

12. The touch panel as claimed in claim 10, wherein the first plate/membrane is a membrane, and the first electrode series and the second electrode series are located at two opposite sides of the membrane.

13. The touch panel as claimed in claim 9, further comprising a cover plate, wherein the first electrode series are disposed on the first plate/membrane, and the second electrode series are disposed on the second plate/membrane, the first plate/membrane and the second plate/membrane are sequentially stacked, and one of the first electrode series and the second electrode series is located between the first plate/membrane and the second plate/membrane, and the other one is not located therebetween, the cover plate is adhered on the first plate/membrane and the second plate/membrane.

14. The touch panel as claimed in claim 1, wherein each of the first electrodes has a first main pattern extending along the first direction and a plurality of first sub patterns connected to the first main pattern, each of the second electrodes has a second main pattern extending along the second direction and a plurality of second sub patterns connected to the second main pattern, and the first sub patterns and the second sub patterns are alternatively arranged.

15. The touch panel as claimed in claim 14, wherein the first sub patterns of each of the first electrodes extends outwards from the first main pattern, and an extending direction of the first sub patterns is not parallel to the first direction.

16. The touch panel as claimed in claim 15, wherein the extending direction of the first sub patterns is parallel to the second direction.

17. The touch panel as claimed in claim 15, wherein the extending direction of at least one of the first sub patterns extending outwards from the first main pattern points to a center of one of the adjacent second electrodes.

18. The touch panel as claimed in claim 15, wherein the extending direction of at least one of the first sub patterns extending outwards from the first main pattern is parallel to the second direction and then points to a center of one of the adjacent second electrodes.

19. The touch panel as claimed in claim 15, wherein the first sub patterns have different pattern widths.

20. The touch panel as claimed in claim 1, wherein each of the first electrodes and each of the second electrodes respectively have a symmetric contour.

21. The touch panel as claimed in claim 14, wherein each of the second sub patterns of each of the second electrodes comprises a main branch and a plurality of sub branches, the sub branches are connected to the main branch, the main branch extends outwards from the second main pattern, and an extending direction of the main branch is not parallel to the second direction.

22. The touch panel as claimed in claim 21, wherein an extending direction of each of the sub branches extending outwards from the main branch is parallel to the second direction and then points to a center of one of the adjacent first electrodes.

23. The touch panel as claimed in claim 21, wherein the extending direction of each of the sub branches extending outwards from the main branch is parallel to the second direction.

24. The touch panel as claimed in claim 21, wherein an extending direction of each of the sub branches extending outwards from the main branch points to a center of one of the adjacent first electrodes and is then parallel to the second direction.

25. The touch panel as claimed in claim 21, wherein a width of the main branch is greater than a width of each of the sub branches.

26. The touch panel as claimed in claim 1, wherein a length and a width of the unit sensing area are respectively equal to pitches of the first electrodes in the first direction and the second direction.

27. The touch panel as claimed in claim 1, wherein the first electrode series and the second electrode series are made of metal material and patterned in the form of mesh.

28. The touch panel as claimed in claim 27, wherein the carrier component compries an indentation, and the first electrode series and the second electrode series are disposed within the indentation.
